(19) United States
(12) Patent Application Publication
(10) Pub. No.: US 2025/0239944 A1
(43) Pub. Date: Jul. 24, 2025

(54) POWER MODULE GATE OXIDE SELF-HEALING METHOD

(71) Applicant: Ford Global Technologies, LLC, Dearborn, MI (US)

(72) Inventors: Petros G. Taskas, Novi, MI (US); Baoming Ge, Okemos, MI (US)

(21) Appl. No.: 18/418,798

(22) Filed: Jan. 22, 2024

(51) Int. Cl. H02M 7/5387; B60L 50/51; H02M 1/088

(52) U.S. Cl. CPC H02M 7/53871; B60L 50/51; H02M 1/088; B60L 2210/42

(57) ABSTRACT

A controller, while a vehicle is not being driven, closes a switch to directly connect windings of an electric machine with a center point of a traction battery, and operates an inverter system controller between the electric machine and traction battery to maintain switches of the inverter system controller at a predefined temperature for a predefined period.

### TECHNICAL FIELD

This disclosure relates to automotive power systems.

### BACKGROUND

An automotive vehicle may use electrical energy to power an electric machine.

The electric machine may convert this electrical energy to mechanical energy to propel the vehicle. The automotive vehicle may include various power electronics equipment to condition and store electrical energy.

### SUMMARY

An automotive power system includes a traction battery, an electric machine including Y-connected windings, an inverter system controller connected between the traction battery and electric machine, and a switch having a terminal directly connected with a center point of the traction battery and a terminal directly connected with a neutral point of the Y-connected windings.

A method includes, during a park mode, closing a switch to directly connect a center point of a traction battery and a neutral point of Y-connected windings of an electric machine, and operating an inverter system controller connected between the traction battery and electric machine to maintain switches thereof at a predefined temperature for a predefined period.

A vehicle includes a traction battery, an electric machine, an inverter system controller connected between the traction battery and electric machine, a switch connected between the traction battery and windings of the electric machine, and a controller that, while the vehicle is not being driven, closes the switch and operates the inverter system controller to maintain switches thereof at a predefined temperature for a predefined period.

### BRIEF DESCRIPTION OF THE DRAWINGS

FIG. 1 is a schematic diagram of an automotive power system.

FIG. 2 is a block diagram of a closed-loop power module gate oxide self-restoration control algorithm.

FIG. 3 shows simulated power switch current waveforms associated with the automotive power system of FIG. 1 and closed-loop power module gate oxide self-restoration control algorithm of FIG. 2.

FIG. 4 shows simulated power switch temperature waveforms associated with the automotive power system of FIG. 1 and closed-loop power module gate oxide self-restoration control algorithm of FIG. 2.

FIG. 5 shows simulated power switch loss waveforms associated with the automotive power system of FIG. 1 and closed-loop power module gate oxide self-restoration control algorithm of FIG. 2.

FIG. 6 shows simulated battery current waveforms associated with the automotive power system of FIG. 1 and closed-loop power module gate oxide self-restoration control algorithm of FIG. 2.

FIG. 7 shows simulated phase current and battery voltage waveforms associated with the automotive power system of FIG. 1 and closed-loop power module gate oxide self-restoration control algorithm of FIG. 2.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Electric vehicles may use an inverter system controller to provide electrical power to the motor to propel the vehicle. The inverter system controller can use insulated-gate bipolar transistor or silicon carbide devices to convert DC power to AC power to power the motor and convert AC to DC to charge the battery. These power devices are some of the significant components of the inverter system controller.

These devices require a certain gate voltage to be optimized for efficiency and to operate properly. The threshold voltage is where the device first begins to conduct, and the gate voltage from the gate driver circuit is selected to be greater than the threshold voltage of the device based on manufacturer specifications. The gate drive circuit is constructed based on this and operates at one voltage to turn on the device and at another voltage to turn off the device. As the device ages and the gate oxide layer degrades, the threshold voltage for switching the device on and off changes as well. This will cause more losses, and in certain cases will cause the gate drive circuit to not be able to operate the power device at all. These types of issues may require inverter system controller replacement. A main reason for this issue is due to trapped charges in the gate oxide layer in the device. These trapped charges change the threshold voltage which in turn change the turn on and turn off voltage of the device.

The device can go through three stages of aging depending on operation parameters and environmental conditions. The first stage is where the device is in its normal operation, and nothing has changed. The second stage may be when the threshold voltage has started to decrease due to trapped charges. The third stage may be when Fowler-Nordheim tunneling begins and the threshold voltage begins to continuously rise. The latter stages are when more power loss and inefficient operation of the device may become apparent.

Generally, a method used to restore gate oxide includes heating to a temperature of 120° C. for 30 minutes to an hour or longer. This existing method uses the vehicle's positive temperature coefficient heater or heat pump. Using this method, the coolant in the loop must be heated. Another option directs the coolant to the motor and uses the motor to heat the coolant. A third option has the vehicle's gas engine turn on and off to keep the battery charged to operate the positive temperature coefficient heater. Within the context of an electric vehicle, this option uses a plug and electricity to enable the positive temperature coefficient heater to heat the coolant.

These techniques may have disadvantages. The positive temperature coefficient heater is inefficient and uses power from the battery to heat the coolant. The coolant must be pumped and heated the entire duration of the annealing process, causing unnecessary heating of other components in the loop. Such cycling may decrease the lifetime of the positive temperature coefficient heater. The positive temperature coefficient heater may need increased size, and additional cooling routes and valves may be necessary.

This disclosure contemplates strategies and components to restore the device threshold voltage or return it to as close as possible to the stage one threshold voltage. This includes a device self-annealing method to remove trapped charges in the device.

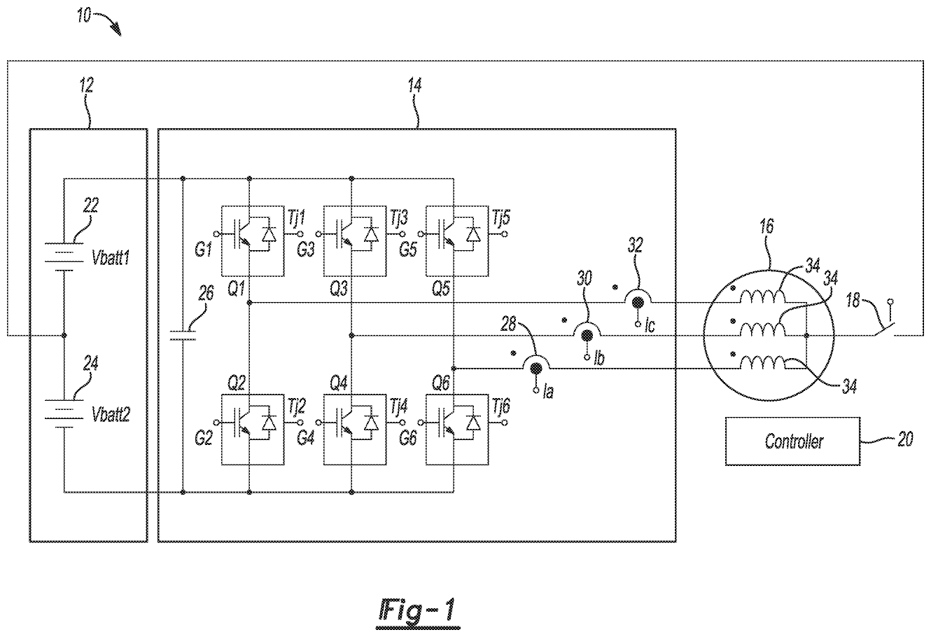

Referring to FIG. 1, a vehicle 10 includes a traction battery 12, an inverter system controller 14, an electric machine 16, a switch 18, and a controller 20. The inverter system controller 14 is connected between the traction battery 12 and electric machine 16. The controller 20 is in communication with/exerts control over the components of the vehicle 10.

The traction battery 12 includes two sets of battery cells 22, 24 thus defining a center point therebetween.

The inverter system controller 14 includes a DC link capacitor 26, current sensors 28, 30, 32 and power switches Q1, Q2, Q3, Q4, Q5, Q6 with corresponding gates G1, G2, G3, G4, G5, G6 and junction temperature sensors Tj1, Tj2, Tj3, Tj4, Tj5, Tj6. The power switches Q1, Q2 are series connected and define a first phase leg of the inverter system controller 14, the power switches Q3, Q4 are series connected and define a second phase leg of the inverter system controller 14, and the power switches Q5, Q6 are series connected and define a third phase leg of the inverter system controller 14. The phase legs are in parallel with each other and the DC link capacitor 26. Each of the current sensors 28, 30, 32 is arranged to detect a current associated with one of the phase legs.

The electric machine 16 includes Y-connected windings 34 thus defining a neutral point.

A terminal of the switch 18 taps the neutral point of the Y-connected windings 34. Another terminal of the switch 18 taps the center point of the traction battery 12 between the sets of battery cells 22, 24. When closed, the switch 18 directly connects the neutral and center points.

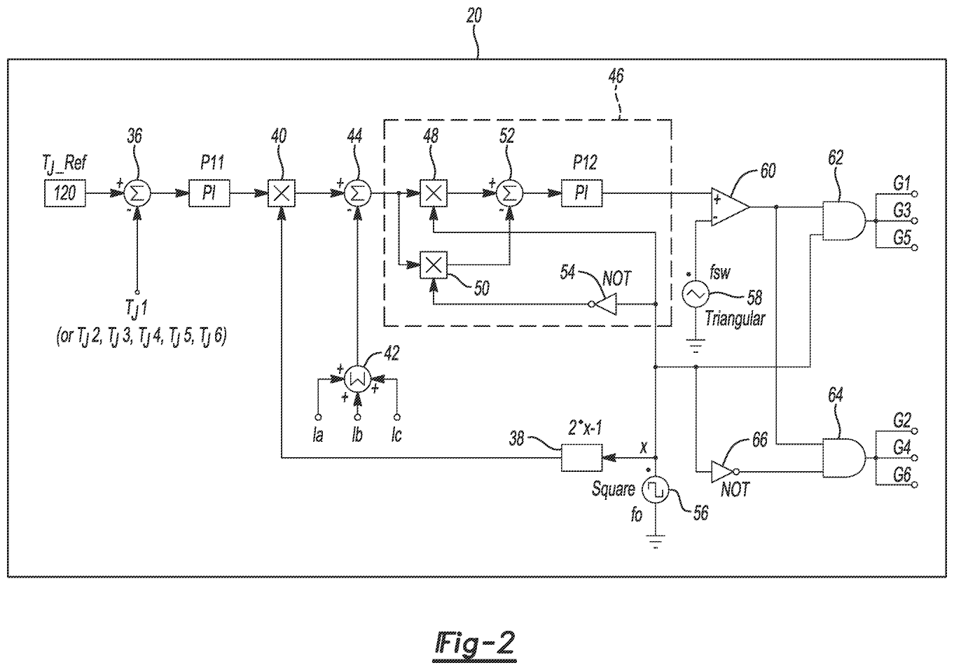

Referring to FIG. 2, a reference temperature (e.g., 120° C.) Tj_Ref and one of the junction temperatures Tji (i=1, 2, 3, . . . , 6) are differenced at operation 36. The resulting difference is provided to proportional integral block PI1. The output of proportional integral block PI1 and output from feedback block 38 are multiplied at operation 40. The phase currents are summed at operation 42. The resulting product from operation 40 and resulting sum from operation 42 are differenced at operation 44. The resulting difference is provided to block 46, which includes multiply operation 48, 50, difference operation 52 proportional integral block PI2, and NOT gate 54 arranged as shown. Output from square wave generator 56 is provided to feedback block 38 and block 46. Output from block 46 and triangular wave generator 58 is provided to comparator 60. The resulting output is provided to AND gates 62, 64. Output from square wave generator 56 is provided to AND gate 62 and NOT gate 66. Output from NOT gate 66 is provided to AND gate 64. Output from AND gate 62 influences control of gates G1, G3, G5. Output from AND gate 64 influences control of gates G2, G4, G6.

When the vehicle 10 is being driven, the switch 18 is open. The proposed strategy is disabled, and the inverter system controller 14 and electric machine 16 are controlled by traditional control strategies.

When the vehicle 10 is not being driven (e.g., while parked) and restoration of the power switches Q1, Q2, Q3, Q4, Q5, Q6 is needed, the switch 18 is closed and the closed-loop power module gate oxide self-restoration control algorithm is executed to maintain the junction temperatures at a predefined temperature for a predefined duration of time (e.g., 120° C. for 30 minutes to 1 hour or longer if necessary). This process can be repeated whenever the threshold voltage of the device increases or decreases out of range of the stage one threshold voltage, which can be detected via known sensors and techniques.

Tj_Ref is the target junction temperature of the power switches Q1, Q2, Q3, Q4, Q5, Q6, which is set in this example to 120° C. Other temperatures may be necessary depending on power switch type, etc. The feedback temperatures are from the junction temperature sensors Tj1, Tj2, Tj3, Tj4, Tj5, Tj6. It can be a single device temperature or the average temperature of all the power switches Q1, Q2, Q3, Q4, Q5, Q6. The proportional and integral (PI) controller PI1 is employed to control actual junction temperature of the power switches Q1, Q2, Q3, Q4, Q5, Q6 and its output is the target current of the sum of the three winding currents. The second PI controller PI2 is employed to make the motor winding current track the reference current, where the gate control signals G1, G2, G3, G4, G5, G6 control the power switches Q1, Q2, Q3, Q4, Q5, Q6, respectively. The carrier signal has a frequency fsw that defines the switching frequency of the power switches Q1, Q2, Q3, Q4, Q5, Q6. The square wave has a 50% duty cycle and its frequency fo defines the fundamental frequency of currents of the power switches Q1, Q2, Q3, Q4, Q5, Q6.

This strategy will heat the power switches Q1, Q2, Q3, Q4, Q5, Q6 and maintain their junction temperatures at the target temperature (e.g., 120° C.), which achieves restoration of the device's threshold voltage (or returns it as close as possible to the stage one threshold voltage). At the same time, the sets of battery cells 22, 24 maintain a same state of charge to not affect performance of the traction battery 12.

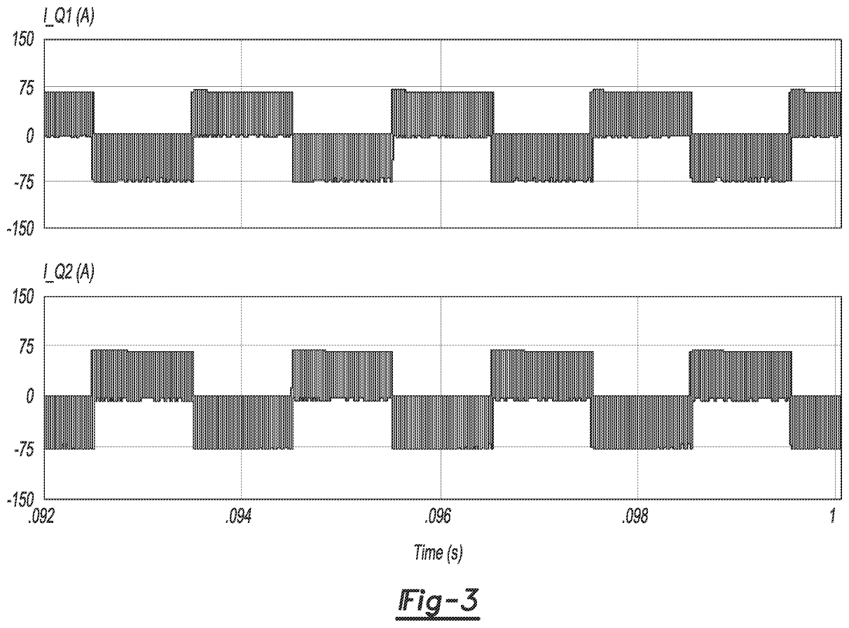

FIGS. 3 through 7 show simulation results when the proposed strategy works to remove trapped charges in the devices, restoring the same. In this example, the target junction temperature is 120° C., the switch 18 is closed, fo=50 Hz, fsw=10 kHz, and the coolant temperature is 70° C. Other values for control parameters may be used based on simulation or testing results. As a result, all the power switches Q1, Q2, Q3, Q4, Q5, Q6 conduct currents at the same time.

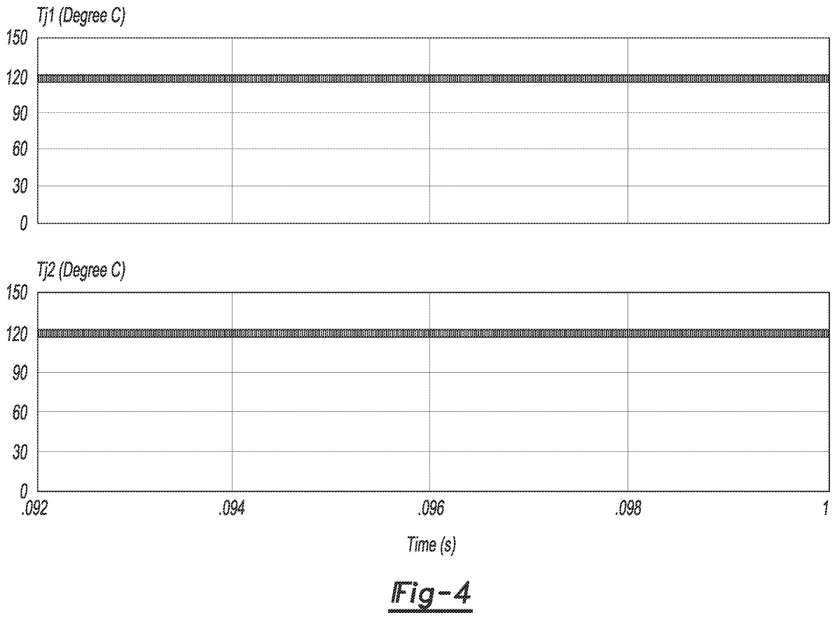

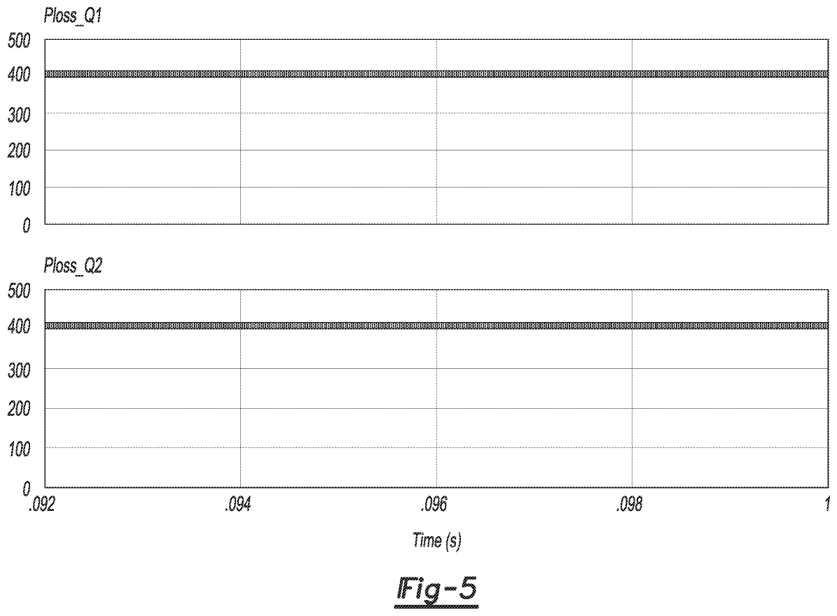

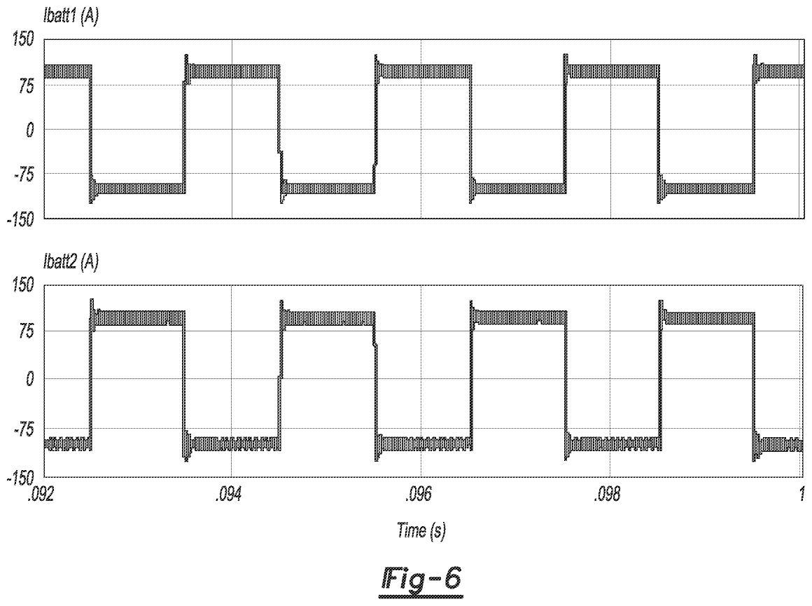

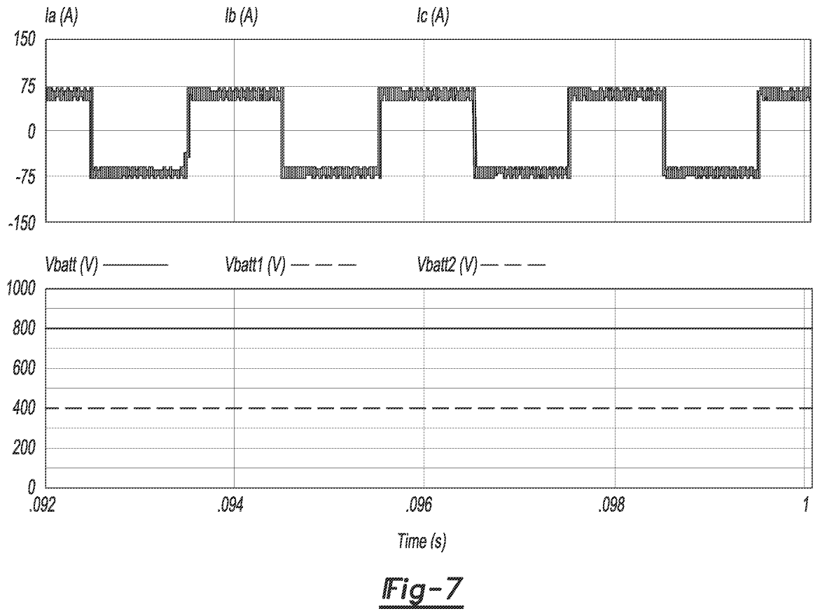

FIG. 3 shows currents of the power switches Q1, Q2. Those currents, and the devices' switching, lead to power losses and make the devices' temperature rise as shown in FIGS. 4 and 5. Each switch has a power loss of 416 W which helps maintain the switch junction temperature at 120° C. FIG. 6 shows the currents of the sets of battery cells 22, 24, where positive and negative current with a frequency of 50 Hz will maintain a constant battery state of charge for both. Also, FIG. 7 shows battery voltages and each phase current of the Y-connected windings 34.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials. The terms “controller” and “controllers,” for example, can be used interchangeably herein as the functionality of a controller can be distributed across several controllers/modules, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An automotive power system comprising:
a traction battery;
an electric machine including Y-connected windings:
an inverter system controller connected between the traction battery and electric machine; and
a switch having a terminal directly connected with a center point of the traction battery and a terminal directly connected with a neutral point of the Y-connected windings.

2. The automotive power system of claim 1 further comprising a controller programmed to, during a park mode, close the switch and operate the inverter system controller to maintain switches thereof at a predefined temperature for a predefined period.

3. The automotive power system of claim 2, wherein the controller is further programmed to operate the inverter via closed-loop control to maintain the switches at the predefined temperature for the predefined period.

4. The automotive power system of claim 2, wherein the controller is further programmed to, after expiration of the predefined period, open the switch.

5. The automotive power system of claim 1, wherein the traction battery includes two sets of battery cells and wherein the center point is between the two sets of battery cells.

6. The automotive power system of claim 5, further comprising a controller programmed to, during a park mode, close the switch and operate the inverter system controller to maintain switches thereof at a predefined temperature for a predefined period such that states of charge of the two sets of battery cells are same.

7. A method comprising:
during a park mode, closing a switch to directly connect a center point of a traction battery and a neutral point of Y-connected windings of an electric machine, and operating an inverter system controller connected between the traction battery and electric machine to maintain switches thereof at a predefined temperature for a predefined period.

8. The method of claim 7, wherein the operating is via closed-loop control.

9. The method of claim 7 further comprising, after expiration of the predefined period, opening the switch.

10. The method of claim 7, wherein the operating is such that states of charge of sets of battery cells on each side of the center point are same.

11. A vehicle comprising:
a traction battery;
an electric machine;
an inverter system controller connected between the traction battery and electric machine;
a switch connected between the traction battery and windings of the electric machine; and
a controller programmed to, while the vehicle is not being driven, close the switch and operate the inverter system controller to maintain switches thereof at a predefined temperature for a predefined period.

12. The vehicle of claim 11, wherein the windings are Y-connected windings, and the switch is connected with a neutral point of the Y-connected windings.

13. The vehicle of claim 11, wherein the traction battery includes two sets of battery cells and a center point therebetween and wherein the switch is connected with the neutral point.

14. The vehicle of claim 13, wherein the controller is further programmed to operate the inverter system controller to maintain the switches thereof at the predefined temperature for the predefined period such that states of charges of the sets of battery cells are same.

15. The vehicle of claim 11, wherein the controller is further programmed to open the switch after expiration of the predefined period.

16. The vehicle of claim 11, wherein the controller is further programmed to operate the inverter system controller via closed-loop control to maintain switches thereof at a predefined temperature for a predefined period.
